(19) United States
(12) Patent Application Publication
(10) Pub. No.: US 2006/0080972 A1
(43) Pub. Date: Apr. 20, 2006

(54) Powered desk caddy

(75) Inventors: Michael Krieger, Miami Beach, FL (US); Kevin Ellsworth, Hollywood, FL (US)

Correspondence Address: VENABLE LLP, P.O. BOX 34385, WASHINGTON, DC, 20045-9998, US

(73) Assignee: Vector Products, Inc., Ft. Lauderdale, FL (US)

(21) Appl. No.: 11/245,114

(22) Filed: Oct. 7, 2005

Related U.S. Application Data
(60) Provisional application No. 60/619,922, filed on Oct. 20, 2004.

(51) Int. Cl. F25B 21/02; F25D 23/12; F17C 13/00; F25D 15/00

(52) U.S. Cl. 62/3.3; 62/3.6; 62/457.9; 62/331

(57) ABSTRACT

A powered desk caddy comprises a caddy body including a bottom surface and a working surface opposite the bottom surface, an electrical outlet located on the caddy body, an AC power inverter located in the caddy body and adapted to receive a DC power input and provide an AC power output to the electrical outlet, a thermo-electric cooler/warmer module located in the caddy body, and a beverage holder cooled/warmed by the thermo-electric cooler/warmer module.

### CROSS-REFERENCE TO RELATED APPLICATIONS

This application claims priority under 35 U.S.C. § 119(e) of U.S. Provisional Patent Application No. 60/619,922, filed on Oct. 20, 2004, the entire content of which is incorporated herein by reference.

### FIELD OF THE INVENTION

The present invention relates generally to portable lap desk caddies, and more specifically, to portable lap desk caddies including one or more electrical components.

### BACKGROUND OF THE INVENTION

Lap desk caddies are known in the art. Conventional lap desk caddies are often used to provide a relatively smooth, stable surface over a user's lap that can be used to support items during activities such as reading, writing, knitting, and eating. Although known lap desk caddies are available in numerous shapes, sizes, and configurations, there remains a need in the art for lap desk caddies that include one or more electrical accessories that increase the functionality of desk caddies.

### SUMMARY OF THE INVENTION

One exemplary embodiment of the present invention is directed to a powered desk caddy, comprising: a caddy body including a bottom surface and a working surface opposite the bottom surface; an electrical outlet located on the caddy body; an AC power inverter located in the caddy body and adapted to receive a DC power input and provide an AC power output to the electrical outlet; a thermo-electric cooler/warmer module located in the caddy body; and a beverage holder cooled/warmed by the thermo-electric cooler/warmer module.

According to one illustrative aspect of the invention, the powered desk caddy can further comprise a cable adapted to connect the AC power inverter to a DC power source. The cable can include a plug adapted to be inserted in a cigarette lighter receptacle.

According to another illustrative aspect of the invention, the electrical outlet can be located on the working surface.

According to yet another illustrative aspect of the invention, the powered desk caddy can further comprise a storage compartment located in the body and cooled/warmed by the thermo-electric cooler/warmer module. The powered desk caddy can include a hinged writing surface located on the work surface, and the storage compartment can be accessible by opening the hinged writing surface.

A second exemplary embodiment of the present invention is directed to a powered desk caddy, comprising: a caddy body including a bottom surface and a working surface opposite the bottom surface; a thermo-electric cooler/warmer module located in the caddy body; and a beverage holder cooled/warmed by the thermo-electric cooler/warmer module.

### BRIEF DESCRIPTION OF THE DRAWINGS

These and other features and advantages of the invention will be further understood from the following detailed description considered in conjunction with the accompanying drawings, which disclose exemplary embodiments of the invention, in which:

FIG. 1 illustrates a first exemplary embodiment of a powered desk caddy according to the present invention;

FIG. 2 illustrates the powered desk caddy of FIG. 1 with an open storage compartment;

FIG. 3 illustrates a second exemplary embodiment of a powered desk caddy according to the present invention;

FIG. 4 illustrates the desk caddy of FIG. 3 with a first storage compartment in an open position; and

FIG. 5 illustrates the desk caddy of FIG. 3 with a second storage compartment in an open position.

### DETAILED DESCRIPTION OF THE INVENTION

Embodiments of the invention are discussed in detail below wherein like reference numbers generally indicate identical, functionally similar, and/or structurally similar elements. While specific exemplary embodiments are discussed, it should be understood that this is done for illustration purposes only. A person skilled in the relevant art will recognize that other components and configurations can be used without departing from the spirit and scope of the invention.

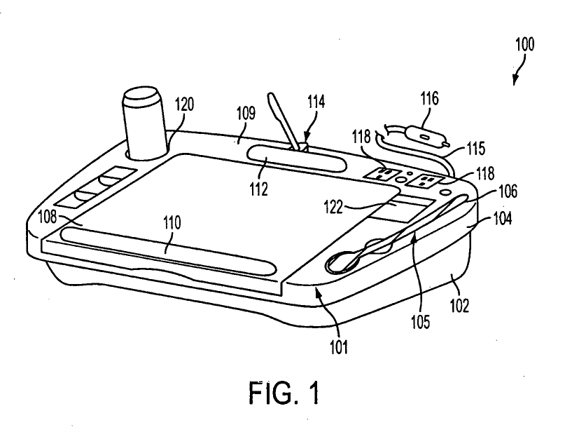

Referring to FIG. 1, a first illustrative embodiment of a desk caddy 100 according to the present invention is shown. The desk caddy 100 includes a body 101 having a bottom surface 102 and an upper, or work surface 104 substantially opposite the bottom surface 102. The body 101 may be formed of, for example, plastic, foam, composites, or other known materials. The bottom surface 102 may be formed of, or may include a layer of, a soft, non-slip material, although other configurations are possible. The non-slip material, if provided, allows the desk caddy 100 to be used on a wide variety of different surfaces with minimal movement. Additionally or alternatively, the bottom surface 102 can be padded to provide a comfortable surface for the desk caddy to rest on the lap of a user. Additionally or alternatively, the bottom surface 102 can also be contoured to fit the lap of a person.

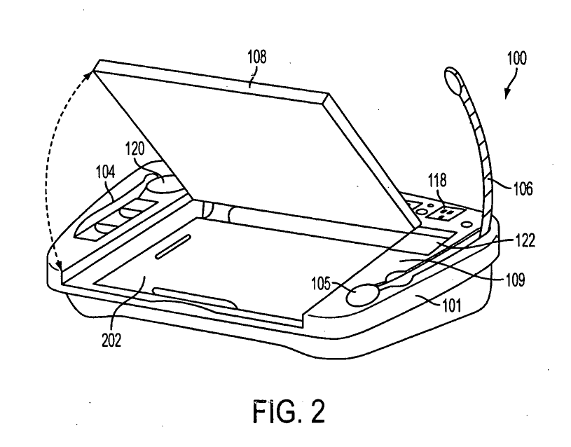

The work surface 104 can include a writing surface 108 and an accessory area 109 surrounding all or a portion of the writing surface 108. The writing surface 108 is preferably a substantially flat surface on which papers or other items can be arranged and written or otherwise marked on. In the exemplary embodiment illustrated in FIG. 1, the writing surface 108 is arranged at a central portion of the work surface 104 and the accessory area 109 is arranged around three sides of the writing surface 108, although other configurations are possible. The writing surface 108 can be hinged at one of its sides to allow the writing surface 108 to be moved between a closed position as shown in FIG. 1, and an open position as shown in FIG. 2. When in the open position, the writing surface 108 reveals a compartment 202.

A variety of accessories can be located on the upper or working surface 104. As shown in FIG. 1, a pair of electrical outlets 118 can be located in the accessory area 109. The electrical outlets 118 can provide AC power similar to that provided from a standard wall outlet, as described in more detail below.

Additionally or alternatively, desk caddy 100 can include a battery powered light emitting diode (LED) task light 106. For example, as shown in FIG. 2, the task light 106 may extend from the work surface 104. The task light 106 may be attached to the work surface 104 with a hinge, and may be stored in a recessed compartment 105 in the work surface 104 when not in use, as shown in FIG. 1.

Referring to FIG. 1, the writing surface 108 may further include a lip 110 to help prevent papers or other objects from sliding off of the writing surface 108. Additionally or alternatively, the work surface 104 may include a clip 112, operative to hold, for example, paper, to the writing surface 108. The clip 112, if provided, may have a receptacle 114 to hold, for example, a pen or pencil.

Desk caddy 100 can include a cable 115 for connecting the desk caddy 100 to an external power source, such as a 12 volt DC power supply. As shown in FIG. 1, cable 115 can include a plug 116 that is adapted to fit into a cigarette-lighter type DC receptacle, such those commonly found in automobiles. Accordingly, cable 115 can supply DC power to one or more electrical components associated with desk caddy 100, as discussed in more detail below.

Desk caddy 100 can also include an AC power inverter located in body 101, such as a 100 watt AC power inverter. The AC power inverter can receive DC power via cable 115 and convert it to AC power that is delivered to the electrical outlets 118. This configuration can allow electronic devices that typically run on AC power, such as laptop computers, to be supported on desk caddy 100 and powered via cable 115. This may be convenient, for example, when using desk caddy 100 as a work surface for AC-powered devices in an automobile.

Still referring to FIG. 1, desk caddy 100 can include a beverage holder 120. For example, in the exemplary embodiment shown, beverage holder 120 is in the form of a generally cylindrical-shaped depression in work surface 104 having a size corresponding to a typical beverage container, although other configurations are possible. The beverage holder 120 may be operative to cool or warm the contents of the beverage holder 120, for example, using a cooler/warmer, such as a thermo-electric heating or cooling module located proximate the beverage holder 120. The heating/cooling module, if provided, may be powered by the DC power supplied via cable 115, or alternatively by the AC output from the AC power inverter, if provided.

Desk caddy 100 can also include a calculator 122 located on the work surface 104. The calculator 122, if provided, can be powered by the DC power supplied via cable 115, or alternatively by the AC output from the AC power inverter, if provided.

FIG. 2 illustrates the desk caddy 100 with the hinged writing surface 108 in an open position. As shown, the hinged writing surface 108 can serve as a lid that provides access to a storage compartment 202, for storing miscellaneous items such as notepads, file folders, and writing utensils.

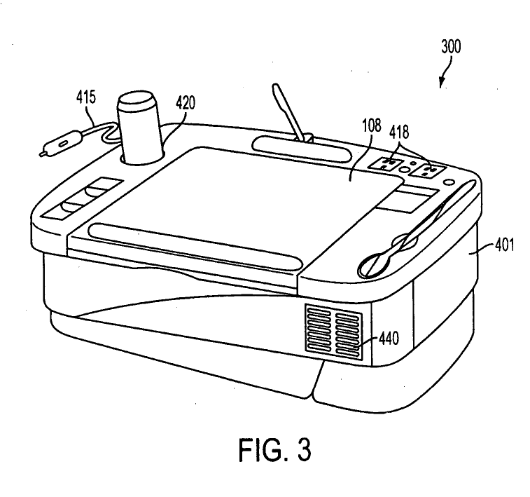

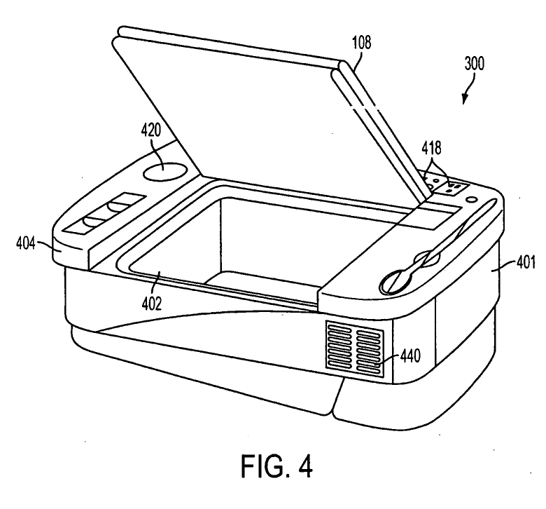

Referring to FIGS. 3-5, another exemplary embodiment of a desk caddy according to the present invention is shown. Desk caddy 300 can have all or some of the features of the desk caddy 100, previously described. In addition, desk caddy 300 can have one or more storage compartments. For example, as shown in FIG. 4, the desk caddy 300 can have a first storage compartment 402. The first storage compartment 402 can be accessible by lifting the hinged writing surface 108, although other configurations are possible. First storage compartment 402 can be cooled/warmed using a cooler/warmer, such as a thermo-electric heating or cooling module located proximate the storage compartment 402. The cooler/warmer can also be used to cool/warm a beverage holder 420 that can be provided in work surface 404.

Similar to the embodiments of FIGS. 1-3, desk caddy 300 can have a power inverter located in the body 401, for example, a 150 watt AC power inverter 440. The power inverter can provide AC power to one or more electrical outlets 418 located on the caddy body 401. The heating/cooling module, if provided, may be powered by the power inverter, or alternatively, by DC power supplied, for example, via a cable 415 (shown in FIG. 3).

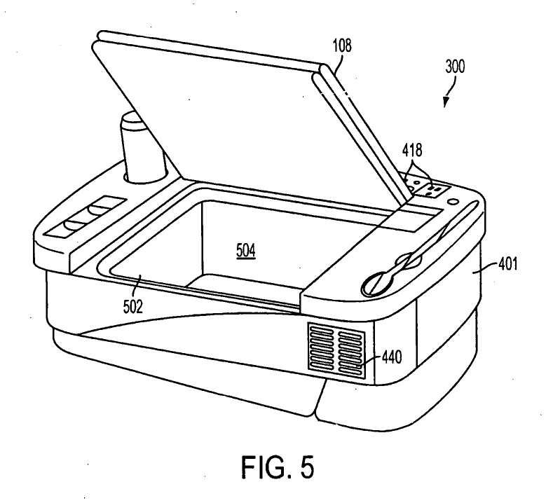

As seen, for example, in FIG. 5, the desk caddy 300 can have a second storage compartment 502. If provided, second storage compartment 502 can occupy the space between the first storage compartment 402 and the hinged writing surface 108. For example, a hinged partition 504 (shown in FIG. 5) can separate the first storage compartment 402 from the second storage compartment 502. Second storage compartment 502 may be used to store miscellaneous items such as notepads, file folders, and writing utensils

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed:

1. A powered desk caddy, comprising:
a caddy body including a bottom surface and a working surface opposite the bottom surface;
an electrical outlet located on the caddy body;
an AC power inverter located in the caddy body and adapted to receive a DC power input and provide an AC power output to the electrical outlet;
a thermo-electric cooler/warmer module located in the caddy body; and
a beverage holder cooled/warmed by the thermo-electric cooler/warmer module.

2. The powered desk caddy of claim 1, further comprising a cable adapted to connect the AC power inverter to a DC power source.

3. The powered desk caddy of claim 2, wherein the cable includes a plug adapted to be inserted in a cigarette lighter receptacle.

4. The powered desk caddy of claim 1, wherein the electrical outlet is located on the working surface.

5. The powered desk caddy of claim 1, wherein the thermo-electric cooler/warmer module is powered by the DC input.

6. The powered desk caddy of claim 1, wherein the thermo-electric cooler/warmer module is powered by the AC power inverter.

7. The powered desk caddy of claim 1, further comprising a storage compartment located in the body and cooled/warmed by the thermo-electric cooler/warmer module.

8. The powered desk caddy of claim 7, further comprising a hinged writing surface located on the work surface, wherein the storage compartment is accessible by opening the hinged writing surface.

9. The powered desk caddy of claim 1, wherein the work surface further comprises a calculator.

10. A powered desk caddy, comprising:
a caddy body including a bottom surface and a working surface opposite the bottom surface;
a thermo-electric cooler/warmer module located in the caddy body; and
a beverage holder cooled/warmed by the thermo-electric cooler/warmer module.

11. The powered desk caddy of claim 10, further comprising an AC power inverter located in the caddy body, and an electrical outlet located on the caddy body, wherein the AC power inverter receives a DC power input and provides an AC power output to the electrical outlet.

12. The powered desk caddy of claim 11, further comprising a cable adapted to connect the AC power inverter to a DC power source.

13. The powered desk caddy of claim 12, wherein the cable includes a plug adapted to be inserted in a cigarette lighter receptacle.

14. The powered desk caddy of claim 11, wherein the electrical outlet is located on the working surface.

15. The powered desk caddy of claim 10, wherein the work surface further comprises a calculator.

16. The powered desk caddy of claim 10, further comprising a storage compartment cooled/warmed by the thermo-electric cooler/warmer module.
